(19) United States
(12) Patent Application Publication
(10) Pub. No.: US 2019/0050769 A1
(43) Pub. Date: Feb. 14, 2019

(54) SYSTEM AND METHOD FOR EVENT BASED COMPUTATIONS

(71) Applicant: WODIFY ARENA LLC, Cherry Hill, NJ (US)

(72) Inventor: Ameet SHAH, Cherry Hill, NJ (US)

(73) Assignee: WODIFY ARENA LLC, Cherry Hill, NJ (US)

(21) Appl. No.: 16/100,866

(22) Filed: Aug. 10, 2018

Related U.S. Application Data
(60) Provisional application No. 62/543,534, filed on Aug. 10, 2017.

(51) Int. Cl. G06Q 10/06; G06Q 10/10; G06F 17/30

(52) U.S. Cl. CPC G06Q 10/06311; G06F 3/0482; G06F 17/3089; G06Q 10/109

(57) ABSTRACT

An event management system and method is disclosed. A computer may communicate with a user device (UD) to exchange information. The computer may receive event information from an organizer UD. The computer may also receive participant information from a plurality of participant UDs. The server may compute a schedule using an algorithm based on the event information and participant information; and then send the schedule to the organizer UD and the plurality of participant UDs. The algorithm may take into account a plurality of variables such as the number of workouts, number of lanes, workout duration, time between heats, divisions, or ranking.

### FIELD OF INVENTION

The subject matter disclosed herein generally relates to the computations made for the organization of an event.

### BACKGROUND

In any planned event there may be one or more organizers who orchestrate the logistics for that event. The event may be a sporting event such as a CrossFit competition, track meet, weightlifting competition, and the like. The process of organizing such an event may be extremely time consuming and may require the attention and focus of many people to plan for and carry out the event to its completion.

### SUMMARY

Methods, systems, and devices for event management is disclosed herein. In an embodiment there may be an event management system operated from a computer that receives event information from a user device (UD). The event information may include heat parameters, workout parameters, and timing parameters. The computer may also receive participant information regarding a plurality of participants. The computer may compute a schedule of heats of the plurality of participants based on the event information and participant information then publish the schedule of heats to a webpage. The computer may receive result information and publish the results, and update the schedule of heats in real time.

### BRIEF DESCRIPTION OF THE DRAWINGS

The following are a list of figures that may be referenced as examples to understand the subject matter disclosed herein:

FIG. 1 is a system diagram of an example event management system;

FIG. 2 is a diagram of an example User Device (UD);

FIG. 3 is a flow chart of an example process for an event management system;

FIG. 4 is an example of an interactive page to receive event information;

FIG. 5 is an example of an interactive page for heats; and

FIG. 6 is an example of an interactive page for publishing schedules, rankings, and the like.

### DETAILED DESCRIPTION

Most events, such as sporting events, require organization of the people and resources for the event. For any given sporting event there may be one or more organizer, participant, judge, and/or observer. Such an event may be an athletic competition, such as a CrossFit competition, track meet, weightlifting competition, and the like, where participants may compete in heats according to some category or class, and judges may evaluate their performance based on a set of rules/metrics. The organizers may establish the rules and organize how, when, and where the participants may compete. The act of organizing the event may be complicated and may be assisted by an event management system capable of event based-computations to determine the logistical planning/information for the people and resources involved. The event management system may be customized to take the size of the event (e.g., the location may permit only a maximum number of people) and/or the length of the event (e.g., hours or days) into consideration in its computation. There may be other customizations as disclosed herein.

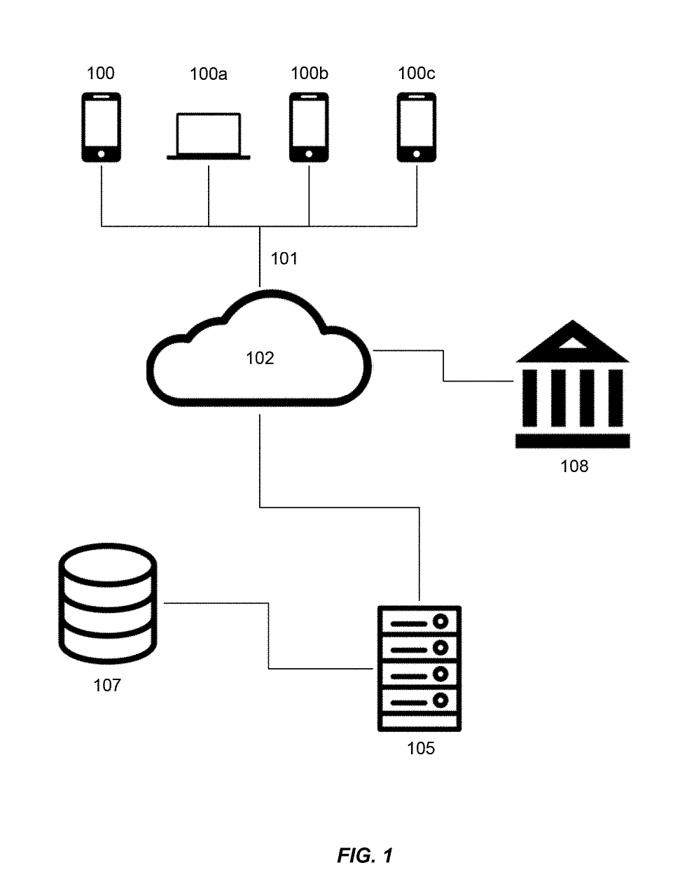

FIG. 1 is a system diagram of an example event management system, such as Wodify Arena Smart Start™. The system may have one or more User Devices (UD) 100, 100a-c that communicate 101 with a network 102 (e.g., Internet) in a wireless or wired manner. As an example, a UD 100 may be a user equipment (UE), a mobile station, a fixed or mobile subscriber unit, a pager, a cellular telephone, a personal digital assistant (PDA), a smartphone, a laptop, a netbook, a tablet, a personal computer, a wireless sensor, consumer electronics, a television, and the like. There may be UD 100 utilized by the people involved in the event, such as a UD 100a for an organizer, a UD 100b for a participant, and a UD 100c for a judge. A UD 100 may be capable of receiving input and providing output to a user operating the UD 100. The UD 100 may also send and receive information through a local area network or the internet. The UD 100 may connect to the internet, which in turn may access a website/service/platform hosted by the server 105 connected by a wired/wireless connection 103. The server 105 and database 107 may represent the infrastructure that facilitates the event management system. In one configuration, the infrastructure may comprise a backend hosted through a farm of several frontend and database servers protected by a firewall and accessed through a load balancer. The event management system may have software that operates on cloud infrastructure such as Amazon® Web Services (AWS), Microsoft® Azure, or the like. The event management system may provide Software as a Service (SaaS) or Software as a Product (SaaP). The server 105 may provide an event management service through a website/service/platform/application programming interface (API). The server 105 may be connected 106 to a database 107 that stores information related to the event received from any of the UDs 100, 100a-c. In an alternative configuration, there may be more than one database 107 and/or the database(s) may be part of the server 105. The server 105 may also interact with a payment service 108 as discussed herein.

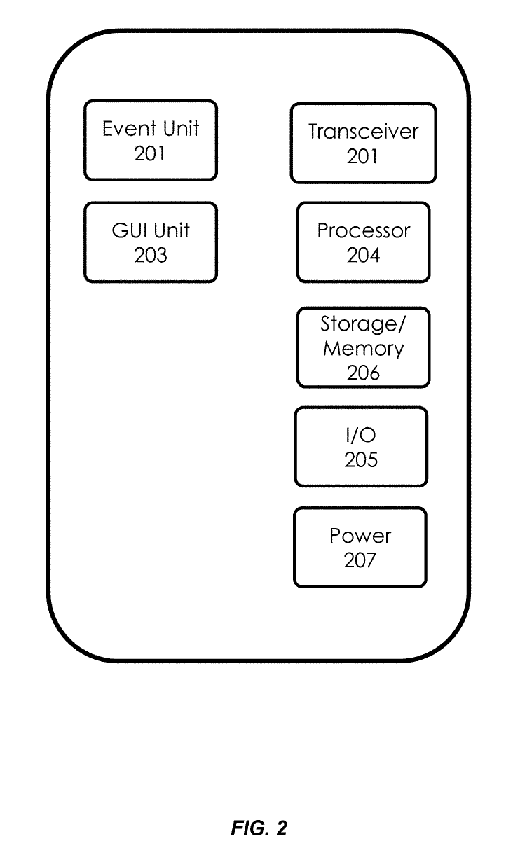

FIG. 2 is an example of a UD. A UD 200 may be described in regards to components, units, and/or functionality that may be performed. A unit or component may represent hardware and/or software that perform a specific function alone or in conjunction with other units. A UD 200 may have an event unit 201, a wireless unit 202, a GUI unit 203, a processing unit 204, an I/O unit 205, a storage/memory unit 206, and/or a power unit 207. A UD 200 may have other hardware or software as is known in the art depending on the type of the device as disclosed herein (e.g., a smartphone may have a camera). For example, a UD 200 may run software/application such as an event unit 201 using the processor 204 (e.g. processor) operatively coupled to the storage/memory (e.g. RAM, hard drive, etc.), the transceiver 202 (e.g. WIFI radio, cellular radio, etc.), and a power component 207. In one example, the transceiver 202 may be a WIFI radio that facilitates a data connection to the internet.

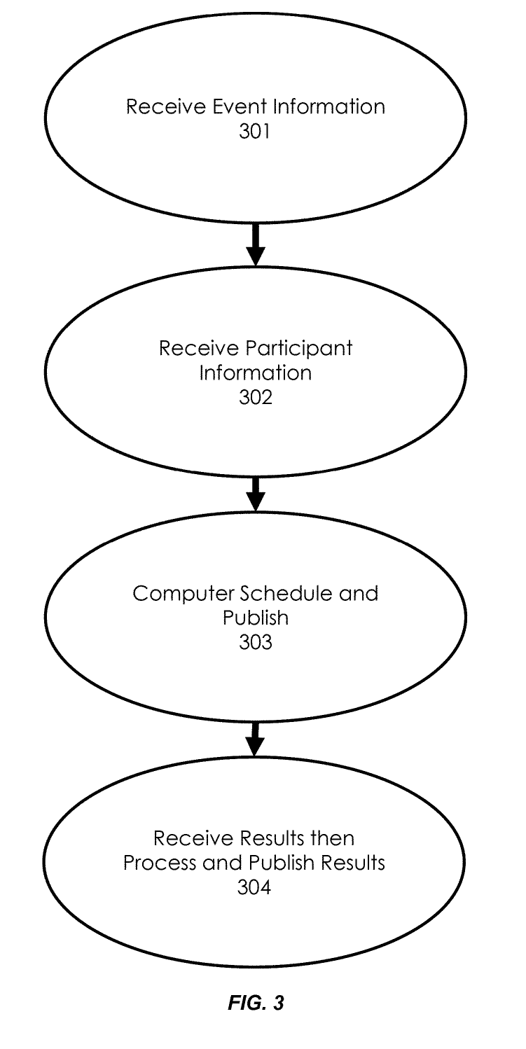

FIG. 3 is a flow chart of an example process for event management. At 301 an event organizer may use a UD to interact with a server to create and manage an event. The organizer may create an interactive event page with event information through a UD 100a running an event unit. There may be specialized versions of an event unit which allows for different capabilities depending on the category of user, such as Organizer, Participant, or Judge.

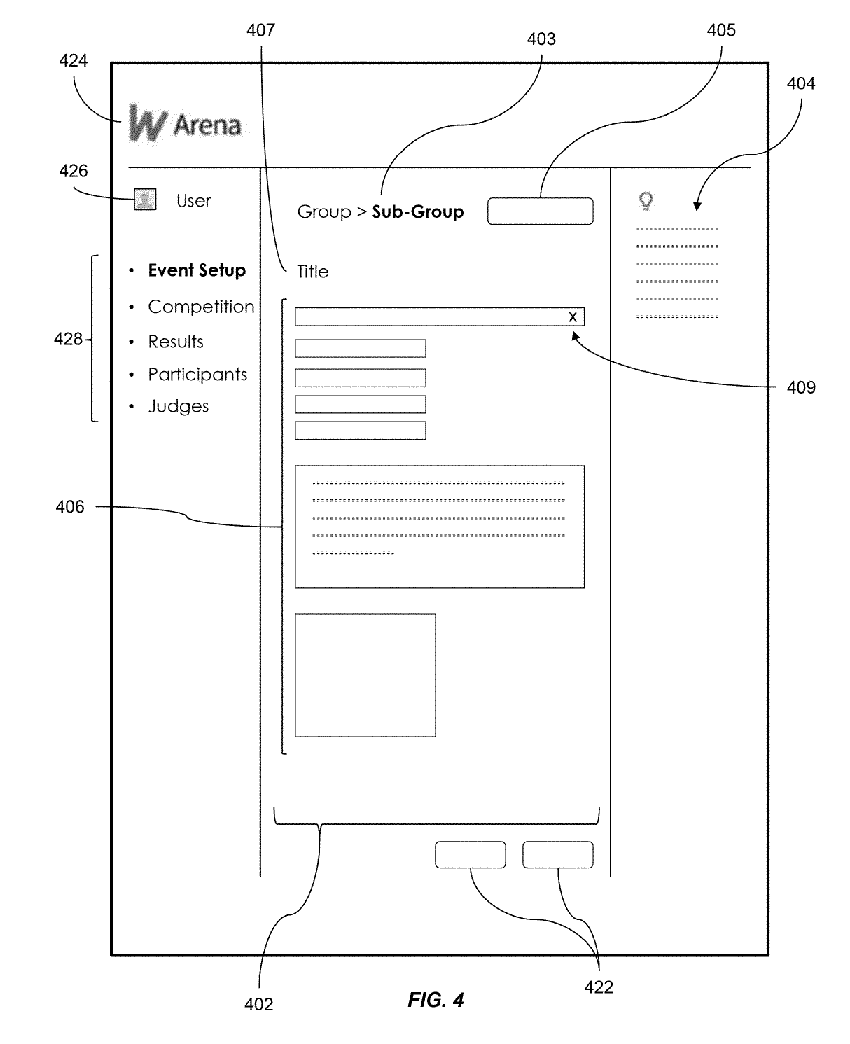

FIG. 4 shows an example screenshot of an interactive webpage or application that allows for a plurality of functions. In one example, the page may allow for the event creation. As discussed herein, a page may refer to a screen of an application or a page of a webpage or interactive site. Generally, there may be a logo 424 of the event management system, an indication of the User 427, a navigation menu 428 to navigate page, a main section 402, and a side section 404. The User may be required to login, using some form of authentication (e.g., user name and password, biometric, two factor authentication, and the like) making access secure, in order interact with the page and the login may determine what the User has access to (e.g., organizers and participants would have access to different features of the event management system). For example, an Organizer would be able to create and modify an event, and a participant may only be able to register for an event and not create or modify an event. The indication of the User 426 may display their name and photo.

Depending on the specific page, the main section 402 may have a title 407 and may contain a form or information that a User may interact with. At 403 the page might have a link and/or a heading indicating the location of the current page within a hierarchy of the overall navigation of the event management system (e.g., group, sub-group). The side section 404 may contain tips, guidelines, or other useful information that may help the User navigate and interact with the page. The main section 402 may comprise text fields, drop down menus, delete buttons 409, and other interactive elements typical to a web page/form. Icons may be used appropriately to signify the purpose of certain functions, such as when entering text there may be a bold letter “B” to make text bold. The form may be saved, canceled, saved and continued to another section, or saved for later completion using buttons 422 at the bottom of the main section 402. Throughout the event creation process, there may be a preview, status, and publish/unpublish button 405. As discussed herein, any disclosure of buttons, links, or other interactive components of the page may be discussed in limited quantities, but in one embodiment there may be any number of such interactive functional components as necessary.

In one example, an organizer may enter event information in 406. The event information may comprise related details about the event such as name, location, time, description, FAQs, social media features, URL, waiver(s) for the Participants, rules, Participant information, Judge information, frequently asked questions and answers, and/or other information related to the event.

In another example, the main section 402 may be used to enter Organizer information, such as the name of the Organization/Organizer who is sponsoring/hosting/running the event, the Organizer's image, and other links or social media connections of the Organizer that the Organizer wants to present with the event. In one case, the event may be co-owned and a User may be able to add one or more other Organizers.

In another example, the main section 402 may be used by the Organizer to define the parameters for the tickets for the event that Participants may purchase. On the page there may be a form to add the details for the tickets. The number of tickets already sold, or the maximum number of tickets available may be also be specified. There may be additional parameters for the tickets sales that the User may determine, such as what information would be required for the sale of the ticket, whether the ticket includes a free gift (e.g., bag, t-shirt which would also require the participant t-shirt size, etc.), waiver information, and the like.

In another example, the main section 402 may have a form to add the details for workouts of the event. The event Organizer may add parameters for the workouts and heats. The workout creation form may also include scoring information regarding scoring methodology, tie breakers, ranking, and other event related details. The Organizer may add a description of the workouts, example videos of the workout, and define options to control when the workout information is published since it may be important when a participant has access to this information in deciding how to prepare for the event.

In another example, the main section 402 the Organizer may enter heat information. The details may include information such as number of lanes/stations, specific heat start times, length of an activity (e.g. workout), change over time between divisions, change over time between heats, division order, and the like. An organizer may also specify customizations such as divisions, max/min total number of participants, max/min number of participants per division, activities of an event, requirements for each activity, required rests for participants/judges, and other related event information. Based on this information, the event management system may generate an estimate/preview of an event schedule without the need for participant information.

Referring to FIG. 3, at 302, once the event management system has received the event information and parameters, the event may be published and participants may register for the event. The registration process may include entering purchase information that may be used with the payment service 107 to facilitate the transaction for the ticket.

For a participant to purchase a ticket the Participant may navigate to a registration page found on or through the event page. Organizers may optionally request that Participants include benchmark workout information when registering; this may enable the event management system, such as Wodify Arena Smart Start™ to generate heats based on Participant input. During registration, Participants may choose the ticket for the division that they would like which will allow the event management system to have various divisions for an event. Once a ticket is selected, Participants may provide Participant information such as contact information, picture of the Participant, gender, age, height, weight, gym membership, competition information, workout information, performance statistics, payment information, and any other information defined by the event organizer for the registration process. The Participant picture may be captured by a camera unit of a UD 100b and uploaded during registration, or the participant picture may already be stored on the UD 100b. The participant information may also already be stored with the event management system in database 106 from prior registration, including results information from prior events. If the participant information was previously stored, then the participant information may be received and processed by the server 105 and stored in the database 106 with the permission of the participant. Participants may have an account with a registration system separate and/or part of the event management system such as Wodify Core, which the event management system such as Wodify Arena Smart Start™ may access. The participant may sign into their account during registration to prefill fields that a new user would otherwise have to fill in. Providing certain pieces of information may be required in order for the Participant to complete the registration process.

Referring to FIG. 3, at 303, once all participants have registered and provided the necessary information, the event organizer may use the event management system to compute schedule/heat information based on the participant information and the event information (e.g., any of the aforementioned pieces of information may be used in the computation of the schedule of heats information). In one example, the event management system may be setup to use specific information about the participant (e.g., their past performance at a prior event) to compute the divisions/heats/schedules to enable grouping and/or timing of participants with similar performances. The information about the participant may already be known to the event management system based on past events, or may be accessible from an ancillary system that keeps track of their information based on a participant's routine workout information kept by themselves through an app (e.g., using the Wodify application) or through their local training facility. The computation for scheduling heats may also be based on other metrics taken from either the participant information or the event information. In one example, grouping in the heats may be based on a predictive approach when some aspect (e.g., any of the aforementioned pieces of information) is known and another aspect is unknown.

In an example, the event and schedule may be computed using an algorithm that takes into account the number of workouts, divisions, workout configurations (e.g., number of lanes, workout duration, time between heats/divisions and ranking type) and/or the participants information registered in the event (e.g., which specific workouts they have registered for, expected completion time, past performance, weight, sex, etc.). The system may compute the number of necessary heats for each division and for each workout taking into account the required time frame for each heat using the algorithm. Participants may be ordered, inside of each heat, by a changeable metric, such as a benchmark score (e.g., where such a score may be computed or collected during the Participant registration process). The computation using the algorithm may generate the most time effective solution for event management and all the parties involved.

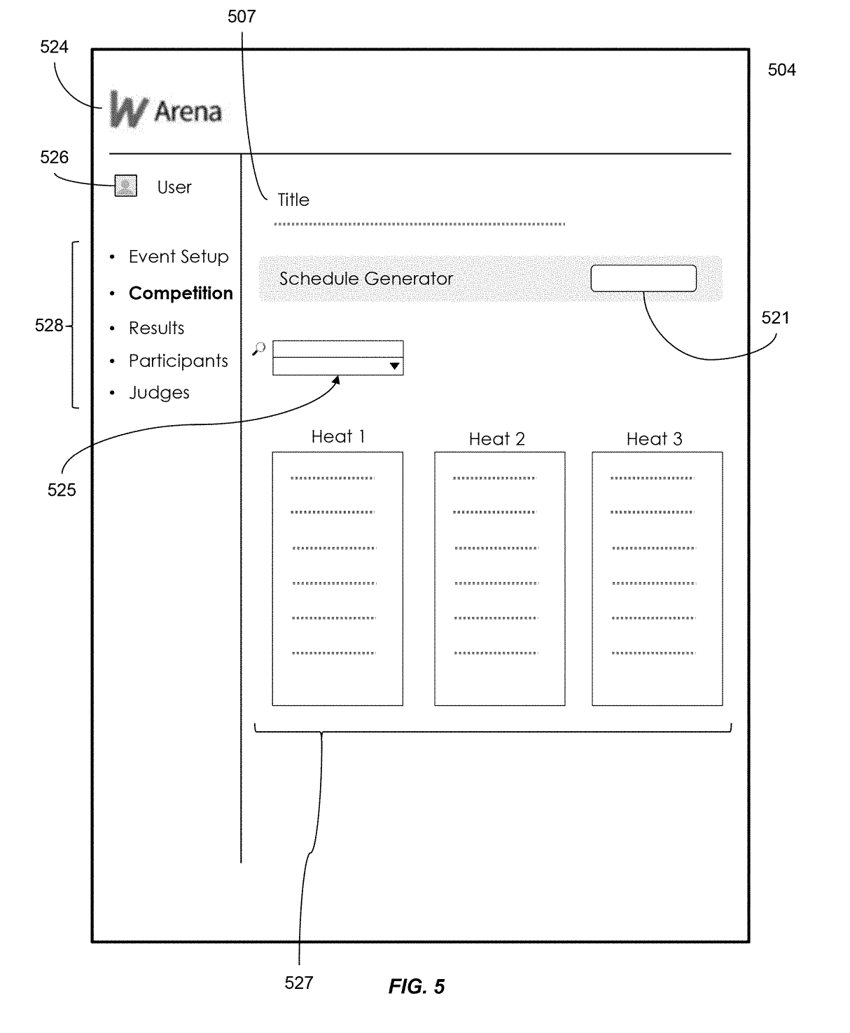

FIG. 5 shows an example of the schedules and heats that may be computed by the event management system. Similar to the other page shown in FIG. 4, there may be a logo 524, an indication of a User 526, a navigation menu 528, and a title 507. The User (i.e., Organizer) may make changes and request the computing of the schedule and heats by pressing a button 521. The schedule may be broken up into different days or events. The schedule 527 may be listed by heats. The User may be able to save changes, add a heat, generate additional schedules, and discard changes. The schedule may be searched 525 using different criteria, such as workout, participant, and the like.

The heats may be generated using a benchmark score if available and participants may be manually moved around into different heats by the organizer. Once computed, the schedule/heats may be exported as a PDF file and/or may be published to the event page for access by people involved in the event.

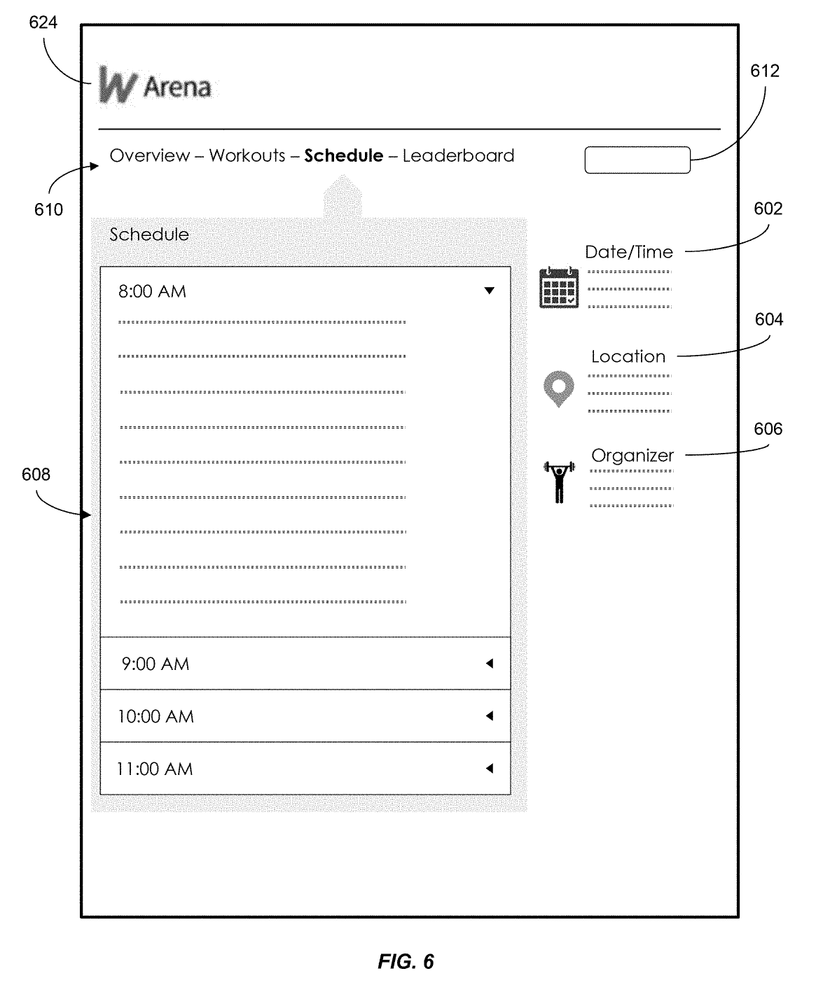

FIG. 6 shows an example of an event page. This page may be intended to display information to the public to entice participants to register using button 612. This page may also include a navigation menu 610, a schedule listing 608, the event time/date 602, the event location 604, and the Organizer(s) 606.

The participants may be notified of their assignment automatically through a UD 100b, or the participants may find out the assignment by looking up the information using a UD 100b.

Once the schedule of heats is computed, the event management system may automatically compute the assignment of judges to specific activities/heats of the event. The assignment of judges may be based on information stored in association with the judge (e.g., availability, expertise, personal schedules, experience, etc.). The judges may be notified of the assignment automatically through a UD 100c, or the judges may find out the assignment by looking up the information using a UD 100c. Alternatively, event organizers may assign judges to heats manually depending on the customizations of the event management system. For automatic assignment, the event management system may consider what the organizer has defined as the maximum consecutive heats and rest-heats to assign judges for a given schedule.

Referring to FIG. 3, at 304 the events result may be sent to and received by the event management system, which may then process and perform rescheduling and ranking. During the event all of the people involved including Participants, Judges, Organizers, and Observers at may use an interactive event page to view the schedule/heats and results throughout the event. For example, the event management system may receive information from Participants, Organizers, and/or Judges relating to the results of the event which are then used to automatically update/compute the schedule/heats and results in real time. A judge may enter results of a participant's workout/performance directly into a UD; afterward, the ranking/results/leaderboard may be updated in real time (e.g., such as on a public webpage or through an app for the event).

The event management system may generate a specific page/screen to be presented on a display at the event, such as a TV. The event management system may also generate a specific page/screen to be accessed via a UD 100. In either case, the information may be automatically visually organized to suit the display hardware of the UD that is accessing the event management system thereby providing an easier to use system for all of the people involved in the event.

The ability to adaptively tailor the display of information to any UD may avoid burdening the organizers from having to answer questions from Participants, Judges, and/or Observers. The ease of access to the event management information may enable the event to proceed more quickly than if the information was more difficult to access. The event management system may provide a page/screen that includes the schedule, heats, activities (e.g., workouts), and scoreboard/leaderboard that may be displayed with up to date information in real time. In one example, if the Organizer has chosen to do a championship workout, they may use the event management system to assign the top participants to heats for a final workout. At the end of an event, the results, including but not limited to winners and final scores may be published so that all of the people involved are able to view the results information.

Examples and use cases are described above in particular combinations and configurations, however, one of ordinary skill in the art will appreciate that each feature or element may be used alone or in any combination with the other features and elements of an example or use case. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a UD, server, or the like.

What is claimed is:

1. A method for event based management and computation performed by a computer, comprising:
receiving event information from a user device (UD), wherein the event information includes heat parameters, workout parameters, and timing parameters;
receiving participant information regarding a plurality of participants;
computing a first schedule of heats of the plurality of participants based on the event information and participant information; and
publishing the schedule of heats to a webpage.

2. The method of claim 1, wherein the event information further includes scoring information, and further comprising:
receiving result information from one or more judge UDs regarding the plurality of participants;
calculating ranking information of the plurality of participants in real time based on the result information and the scoring information; and
publishing the ranking information to a publicly available website.

3. The method of claim 2, further comprising computing a second schedule of heats in real time based on the result information.

4. The method of claim 3, further comprising automatically assigning one or more judges to the second schedule of heats once the results of the first schedule of heats has been received.

5. The method of claim 4, further comprising reassigning the one or more judges to the second schedule of heats.

6. The method of claim 5, wherein event information further includes the following parameters: number of workouts, number of lanes, workout duration, time between heats, time limit per workout, and start time.

7. A computer with a processor operatively connected to a transceiver, the processor and transceiver configured to:
receiving event information from an organizer device (UD), wherein the event information includes heat parameters, workout parameters, and timing parameters;
receiving participant information regarding a plurality of participants;
computing a first schedule of heats of the plurality of participants based on the event information and participant information; and
publishing the schedule to a webpage.

8. The server of claim 7, wherein the event information further includes scoring information, and wherein the processor and transceiver are further configured to:
receive result information from one or more judge UDs regarding the plurality of participants;
calculate ranking information of the plurality of participants in real time based on the result information and the scoring information; and
publish the ranking information to a publicly available website. The server of claim 8, wherein the processor and transceiver are further configured to compute a second schedule in real time based on the result information.

10. The server of claim 9, wherein the processor and transceiver are further configured to automatically assign one or more judges to the second schedule of heats once the results of the first schedule of heats has been received.

11. The server of claim 10, wherein the processor and transceiver are further configured to reassigning the one or more judges to the second schedule of heats.

12. The server of claim 11, wherein event information further includes the following parameters: number of workouts, number of lanes, workout duration, time between heats, time limit per workout, and start time.
